(19) United States
(12) Patent Application Publication
(10) Pub. No.: US 2025/0043835 A1
(43) Pub. Date: Feb. 6, 2025

(54) BRAKE APPARATUS FOR VEHICLE

(71) Applicant: HYUNDAI MOBIS CO., LTD., Seoul (KR)

(72) Inventors: Sang Pil BOO, Yongin-si (KR); Yeon Jun LEE, Yongin-si (KR); Bo Ram YOON, Yongin-si (KR)

(73) Assignee: HYUNDAI MOBIS CO., LTD., Seoul (KR)

(21) Appl. No.: 18/592,295

(22) Filed: Feb. 29, 2024

(30) Foreign Application Priority Data
Aug. 2, 2023 (KR) 10-2023-0101091

(51) Int. Cl. F16D 55/226; F16D 65/00; F16D 55/00

(52) U.S. Cl. CPC F16D 55/226; F16D 65/0068; F16D 2055/0016

(57) ABSTRACT

A brake apparatus for a vehicle includes a cylinder housing a piston, a caliper body disposed on the outer side of the cylinder and surrounding a portion of the cylinder, a driver coupled with the cylinder and generating driving force to move the piston, and a coupling member coupling the cylinder with the caliper body.

### CROSS-REFERENCE TO RELATED APPLICATION

This application claims priority from and the benefit of Korean Patent Application No. 10-2023-0101091, filed on Aug. 2, 2023, which is hereby incorporated by reference for all purposes as if set forth herein.

### BACKGROUND

### Field

Exemplary embodiments of the present disclosure relate to a brake apparatus for a vehicle and, more particularly, to a brake apparatus for a vehicle that ensures stable braking performance.

### Discussion of the Background

In general, vehicle brake systems utilize driving force to push a piston, bringing a pad and a disc into close contact, and use friction between the pad and the disc to brake a vehicle.

Among the vehicle brake systems, an electro-mechanical brake (EMB) is a system that generates braking force by pressurizing a piston through a mechanism that converts a rotational movement of a screw into linear movement of a nut, with a motor-driven actuator mounted on a caliper, without using hydraulic pressure.

The EMB is capable of active braking and independent braking for each wheel, enabling the implementation of additional functions such as an anti-lock brake system (ABS), an electronic stability control (ESC), a traction control system (TCS), and an autonomous emergency braking (AEB), in addition to a primary brake system, and has the advantage of achieving higher performance due to the absence of hydraulic transmission delay.

However, the EMB faces an issue where the caliper body may deform under the applied load when the caliper generates braking force. Therefore, there is a need for improvement in this issue.

The related art of the present disclosure is disclosed in Korean Patent Publication No. 10-2010-0098846 (published on Sep. 10, 2010, and entitled “DISK BRAKE HAVING PARKING FUNCTION”).

### SUMMARY

The present disclosure has been made in an effort to solve the above-mentioned problem, and an object of the present disclosure is to provide a brake apparatus for a vehicle that ensures the rigidity of a caliper, leading to improved braking performance.

According to the present disclosure, a brake apparatus for a vehicle includes: a cylinder housing a piston, a caliper body disposed on the outer side of the cylinder and surrounding a portion of the cylinder, a driver coupled with the cylinder and generating driving force to move the piston, and a coupling member coupling the cylinder with the caliper body.

The coupling member may include one or more first coupling members coupling the cylinder with the caliper body in a first direction.

The caliper body may have one or more first through-holes through which a portion of the respective first coupling members passes, and the cylinder may have one or more first flanges protruding from an outer circumferential surface thereof.

Each of the first flange may have a first tab, coupled with a corresponding one of the first coupling members passing through a corresponding one of the first through-holes.

The caliper body may have one or more first suspension portions, protruding from an inner surface thereof and making contact with an outer surface of a corresponding one of the first flanges.

The coupling member may include one or more second coupling members coupling the cylinder with the caliper body in a second direction.

The cylinder may have one or more second flanges protruding from an outer circumferential surface thereof, and each of the second flanges may have a second through-hole through which a portion of a corresponding one of the second coupling members passes.

The caliper body may have one or more second tabs, each of which is recessed in an inner surface thereof and coupled with a corresponding one of the second coupling members passing through a corresponding one of the second through-holes.

The caliper body may have one or more second suspension portions, each protruding from an inner surface thereof and making contact with an outer surface of a corresponding one of the second flanges.

One or more damper members, which are interposed between the cylinder and the caliper body and are elastically deformable, may be further included.

According to the present disclosure, the rigidity of the caliper body can be ensured through a plurality of coupling members that couple the cylinder with the caliper body, and a plurality of suspension portions that support the flanges. These components bear a shear load when the caliper body generates braking force, thereby minimizing the load applied to the coupling member.

According to the present disclosure, profitability can be increased by improving processes and assembly to enhance productivity and production efficiency.

### BRIEF DESCRIPTION OF THE DRAWINGS

FIG. 1 is a perspective view illustrating a brake apparatus for a vehicle according to a first embodiment of the present disclosure as viewed from above.

FIG. 2 is a perspective view illustrating a brake apparatus for a vehicle according to the first embodiment of the present disclosure as viewed from below.

FIG. 3 is an exploded perspective view of FIG. 1.

FIG. 4 is an exploded perspective view of FIG. 2.

FIG. 5 is a sectional view taken along line A-A of FIG. 1.

FIG. 6 is a perspective view illustrating a brake apparatus for a vehicle according to a second embodiment of the present disclosure as viewed from above.

FIG. 7 is a perspective view illustrating a brake apparatus for a vehicle according to the second embodiment of the present disclosure as viewed from below.

FIG. 8 is an exploded perspective view of FIG. 6.

FIG. 9 is an exploded perspective view of FIG. 7.

FIG. 10 is a sectional view taken along line B-B of FIG. 7.

### DETAILED DESCRIPTION OF THE ILLUSTRATED EMBODIMENTS

Hereinafter, embodiments of a brake apparatus for a vehicle according to the present disclosure will be described in detail with reference to the accompanying drawings. For clarity and convenience in description, thicknesses of lines, sizes of constituent elements, and the like may be illustrated in a non-exact proportion in the drawings. In addition, the terms used below are defined in consideration of the functions thereof in the present disclosure and may vary depending on the intention of a user or an operator or common practice. Therefore, these terms should be contextually defined in light of the present specification.

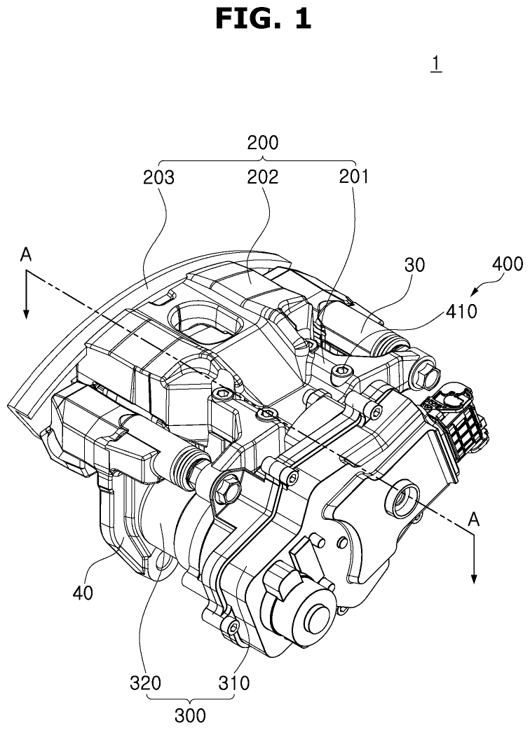

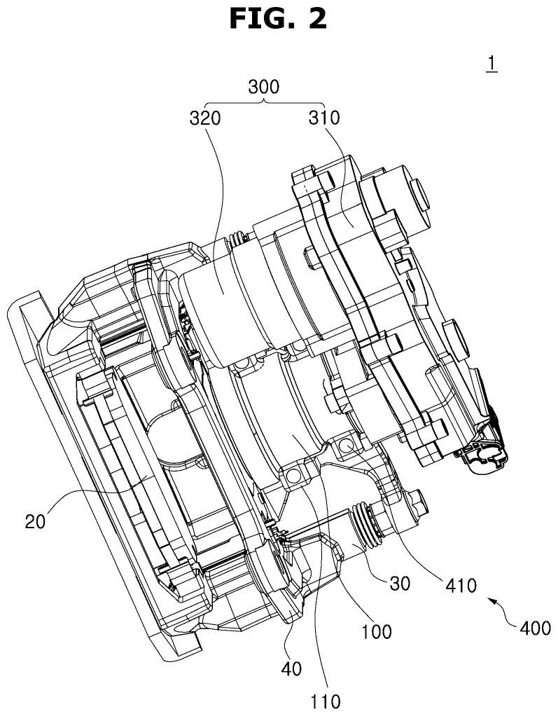

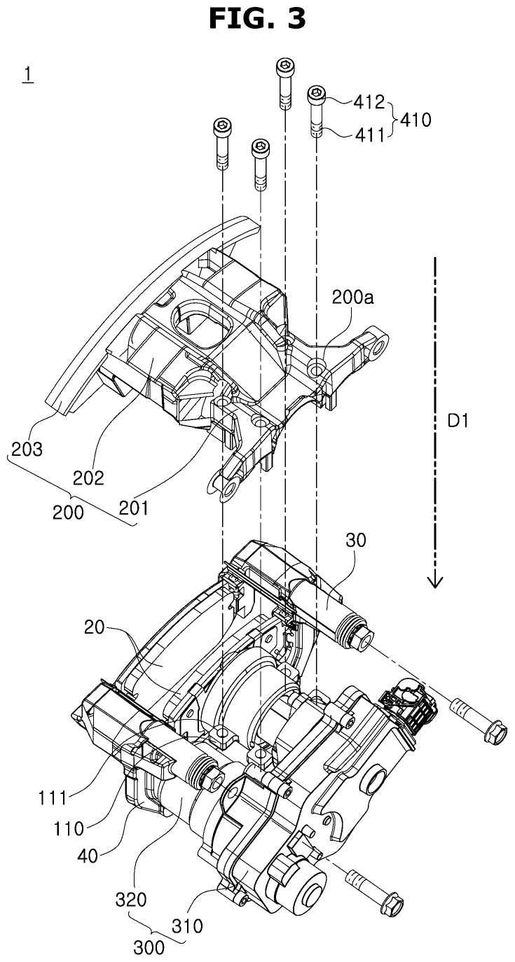

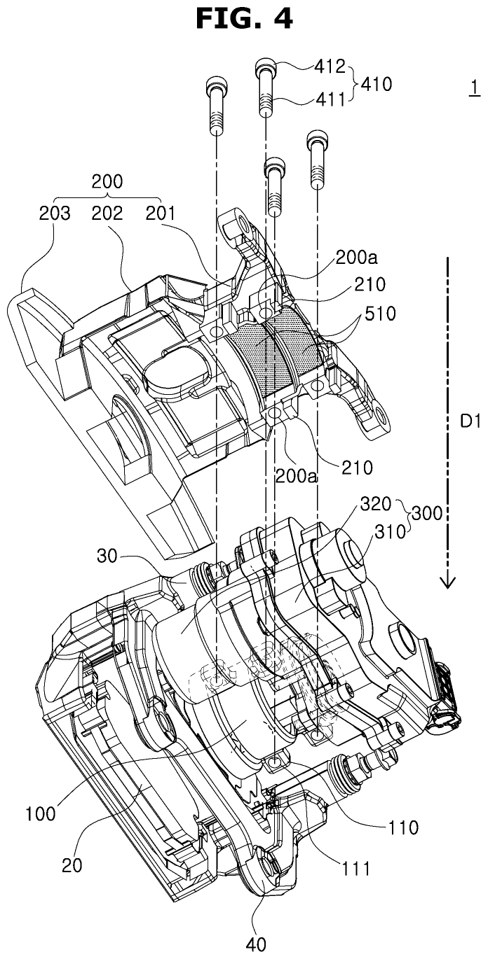

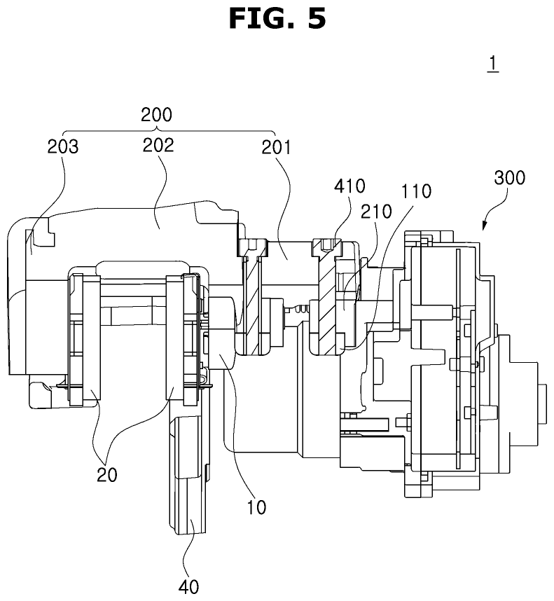

FIG. 1 is a perspective view illustrating a brake apparatus for a vehicle according to a first embodiment of the present disclosure as viewed from above. FIG. 2 is a perspective view illustrating a brake apparatus for a vehicle according to the first embodiment of the present disclosure as viewed from below. FIG. 3 is an exploded perspective view of FIG. 1. FIG. 4 is an exploded perspective view of FIG. 2. FIG. 5 is a sectional view taken along line A-A of FIG. 1.

With reference to FIGS. 1 to 5, a brake apparatus 1 for a vehicle according to the first embodiment of the present disclosure includes a cylinder 100, a caliper body 200, a driver 300, and a coupling member 400, which will be described in more detail below.

The cylinder 100 may be formed in a hollow shape. The cylinder 100 may be formed in a cylindrical shape with one side open. The open side of the cylinder 100 may be disposed to face a brake pad 20 of a pair of brake pads 20. The cylinder 100 may be made of iron or aluminum.

A piston 10 may be housed inside the cylinder 100. The piston 10 may reciprocate in the axial direction of the cylinder 100.

The outer surface of the piston 10 may be slidably supported on the inner surface of the cylinder 100. However, the outer surface of the piston 10 may form clearance by spacing a predetermined distance from the inner surface of the cylinder 100.

The piston 10 may protrude from the cylinder 100 while moving towards the outer side of the cylinder 100 and pressurize the brake pad 20, disposed to face the cylinder 100, towards a brake disc (not illustrated).

The caliper body 200 may define an overall external appearance of a brake apparatus and entirely support the cylinder 100 and the driver 300. The caliper body 200 may be disposed on the outer side of the cylinder 100 and provided to surround a portion of the cylinder 100. The caliper body 200 may be made of iron or aluminum.

The caliper body 200 may include a main body 201, a bridge 202, and a plate 203.

The main body 201 may be seated on the cylinder 100 and provided to surround a portion of the outer circumferential surface of the cylinder 100. In addition, the inner circumferential surface of the main body 201 in contact with the cylinder 100 may be formed in a concave shape having the same curvature as the curvature of the outer circumferential surface of the cylinder 100.

The bridge 202 may define an external appearance of the center portion of the caliper body 200 and support the main body 201 and the plate 203. The bridge 202 may be coupled with a carrier 40 affixed to a knuckle (not illustrated) or the like through a guide rod 30. The bridge 202 may be reciprocally coupled with the carrier 40.

The lower surface of the bridge 202 may be disposed to face a circumferential surface of the brake disc, spaced apart by a predetermined distance. Both sides of the bridge 202 may be extended downward with respect to the brake disc.

The pair of brake pads 20 may be disposed on the lower side of the bridge 202. The pair of brake pads 20 may be disposed to face each other with a brake disc in between. A friction pad, made of a high-friction material such as rubber, may be attached to one side of the brake pad 20, facing the brake disc.

The plate 203 may be extended downward from one side of the bridge 202. The plate 203 may be disposed to face a brake pad 20 of the pair of brake pads 20.

When the bridge 202 moves towards the main body 201, the plate 203 may pressurize the brake pad 20, spaced apart from the brake disc, towards the brake disc.

The driver 300 may be coupled with the cylinder 100 and generate driving force to move the piston 10. In other words, the driver 300 may be coupled with the cylinder 100 and generate driving force to reciprocate the piston 10. The driver 300 may include a housing 310 and an actuator 320.

The housing 310 may be disposed on the outer side of the cylinder 100, with one side thereof facing the closed side of the cylinder 100. The housing 310 may be coupled with the cylinder 100 using various coupling methods, such as bolting and welding.

The actuator 320 may be coupled with the housing 310 and generate rotational force. The actuator 320 may be exemplified by various types of electric motors capable of generating rotational force by receiving power from a vehicle battery (not illustrated) or the like. The center axis of the actuator 320 may be disposed parallel to the center axis of the cylinder 100 or spaced apart from the center axis of the cylinder 100.

The actuator 320 may be affixed to one side of the housing 310, disposed to face the cylinder 100, using various coupling methods, such as bolting and welding.

The coupling member 400 may couple the cylinder 100 and the caliper body 200. The coupling member 400 according to the first embodiment of the present disclosure may include one or more first coupling members 410 coupling the cylinder 100 and the caliper body 200 in a first direction (D1).

The first coupling member 410 may be exemplified by a bolt, which includes a body portion 411 with a screw thread formed along the outer circumferential surface thereof, and a head portion 412 provided on one side of the body portion 411, having a greater diameter than the body portion 411.

The caliper body 200 may have one or more first through-holes 200a. The first through-hole 200a may be formed in the main body 201 of the caliper body 200. A plurality of the first through-holes 200a may be spaced apart from each other along the widthwise direction of the caliper body 200, and another plurality of the first through-holes 200a may be spaced apart from each other along the lengthwise direction of the caliper body 200.

A portion of the first coupling member 410 may pass through the first through-hole 200a. The first through-hole 200a may have a greater diameter than the body portion 411 of the first coupling member 410 and have a lesser diameter than the head portion 412 of the first coupling member 410. Accordingly, the body portion 411 of the first coupling member 410 may pass through the first through-hole 200a.

The cylinder 100 may have one or more first flanges 110, corresponding to the first through-hole 200a. The first flange 110 may protrude from the outer circumferential surface of the cylinder 100.

A plurality of the first flanges 110 may be spaced apart from each other along the circumferential direction of the cylinder 100. A plurality of the first flanges 110 may be spaced apart from each other along the axial direction of the cylinder 100.

The first flange 110 may have a first tab 111. The first tab 111 may pass through the first flange 110 and be recessed in the outer surface of the first flange 110 facing the caliper body 200. A screw thread may be formed on the inner surface of the first tab 111. This may enable a screw-coupling with the body portion 411 of the first coupling member 410 passing through the first through-hole 200a.

The caliper body 200 may have one or more first suspension portions 210. The first suspension portion 210 may be formed on the main body 201 of the caliper body 200 facing the cylinder 100, and protrude from the inner surface of the main body 201. The first suspension portion 210 may be positioned on one side of the first through-hole 200a, making contact with the outer surface of the first flange 110, thereby supporting the first flange 110.

A plurality of the first coupling members 410 is provided to couple the cylinder 100 with the caliper body 200 in the first direction (D1), and a plurality of the first suspension portions 210 is provided on the caliper body 200, making contact with the outer surface of the first flange 110 and thereby supporting the first flange 110. These components may be capable of supporting both a shear load, generated in the axial direction of the cylinder 100, and a vertical load, generated in a direction orthogonal to the axial direction of the cylinder 100, when the caliper body 200 generates braking force, thereby preventing deformation of the caliper body 200.

In other words, it is possible to prevent the deformation that could cause a gap between the main body 201 of the caliper body 200 and the plate 203 of the caliper body 200, with respect to the bridge 202 of the caliper body 200, due to both shear and vertical loads that are applied to the caliper body 200 when generating braking force by the caliper body 200.

A brake apparatus 1 for a vehicle according to the first embodiment of the present disclosure may further include a damper member 510. The damper member 510 may be interposed between the cylinder 100 and the caliper body 200. In other words, the damper member 510 may be affixed to the inner surface of the main body 201 of the caliper body 200, which surrounds the cylinder 100 and makes contact with the outer circumferential surface of the cylinder 100.

The damper member 510 may be made of an elastically deformable material. The elastically deformable material may include rubber, sponge, and the like. The damper member 510 may absorb vibration so that the vibration, generated when the caliper body 200 generates braking force, is not transmitted to the vehicle body.

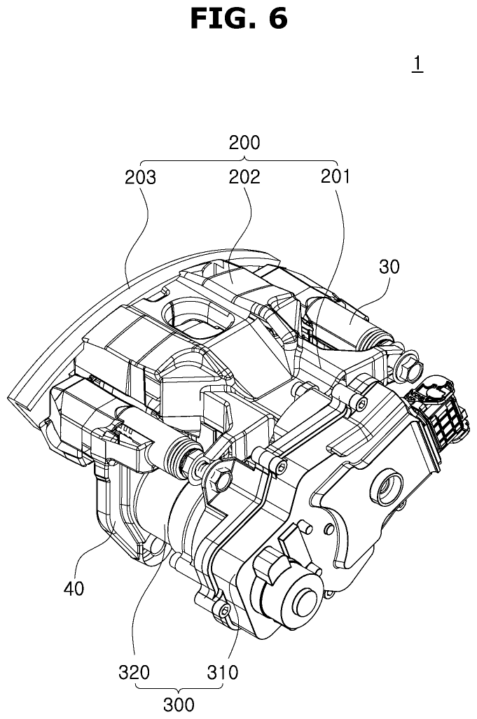

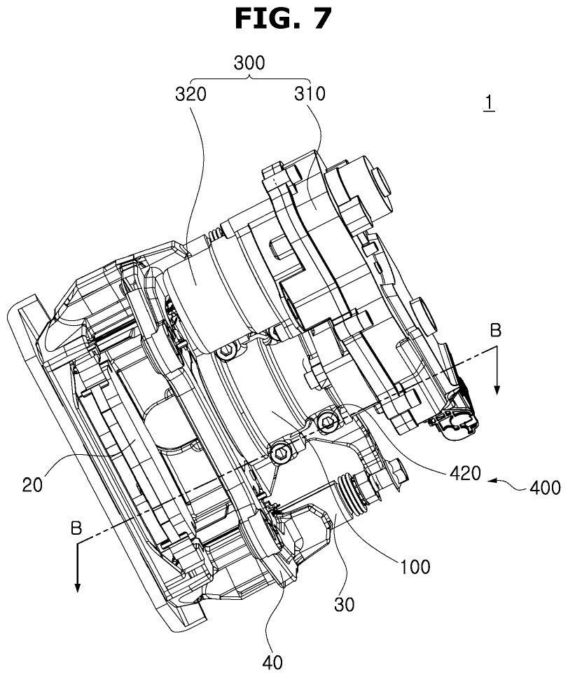

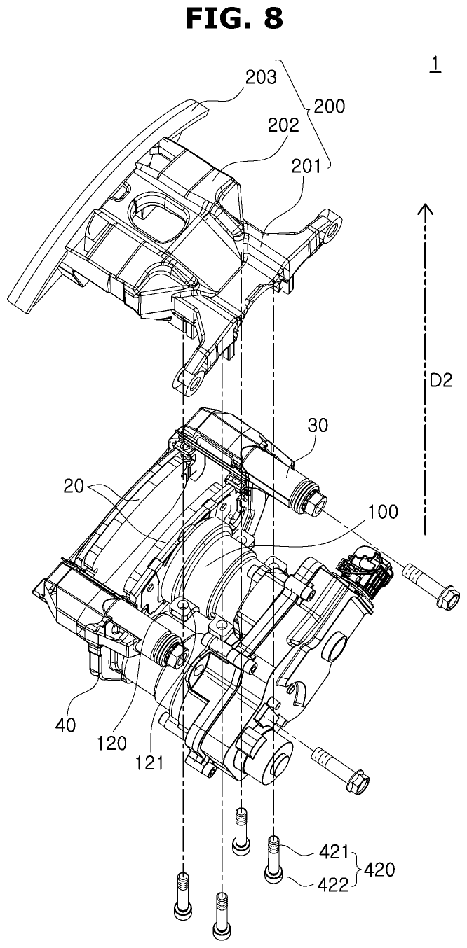

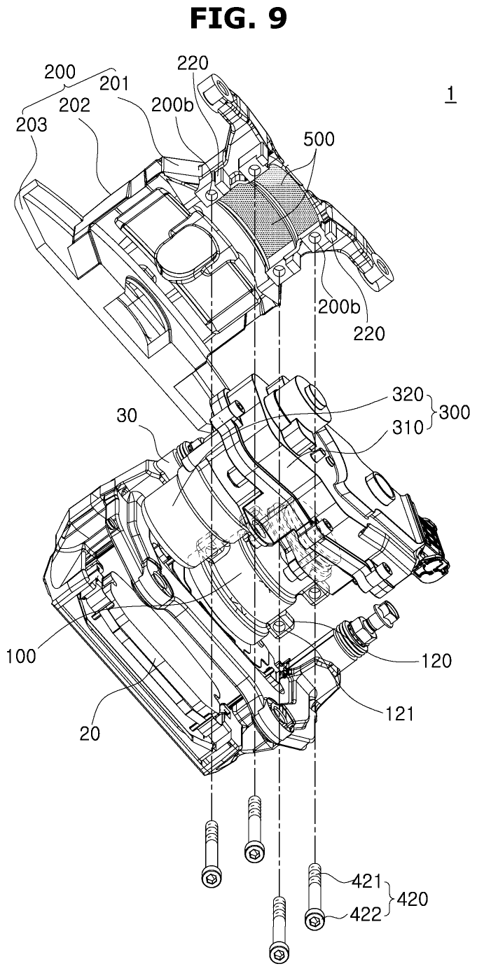

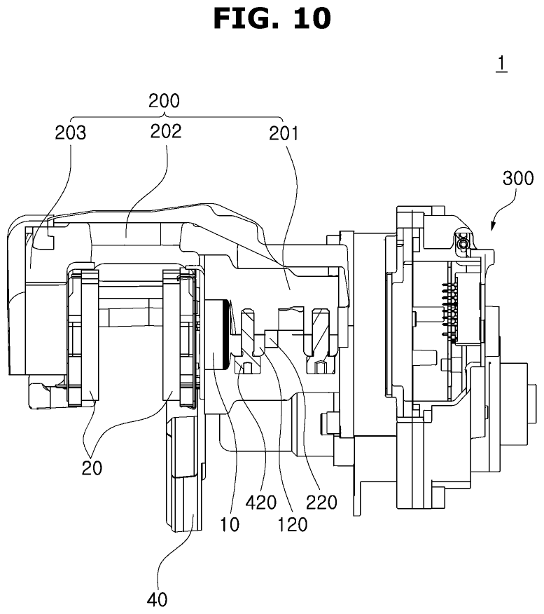

FIG. 6 is a perspective view illustrating a brake apparatus for a vehicle according to a second embodiment of the present disclosure as viewed from above. FIG. 7 is a perspective view illustrating a brake apparatus for a vehicle according to the second embodiment of the present disclosure as viewed from below. FIG. 8 is an exploded perspective view of FIG. 6. FIG. 9 is an exploded perspective view of FIG. 7. FIG. 10 is a sectional view taken along line B-B of FIG. 7.

With reference to FIGS. 6 to 10, a second embodiment of the coupling member 400, in a brake apparatus 1 for a vehicle according to the second embodiment of the present disclosure, will be described. The same reference numerals are assigned to configurations the same as those of the first embodiment of a brake apparatus 1 for a vehicle, as described above with reference to FIGS. 1 to 5, and overlapped descriptions will be omitted.

The coupling member 400 according to the second embodiment of the present disclosure may include one or more second coupling members 420 coupling the cylinder 100 with the caliper body 200 in a second direction (D2).

The second coupling member 420 may be exemplified by a bolt, which includes a body portion 421 with a screw thread formed along the outer circumferential surface thereof, and a head portion 422 provided on one side of the body portion 421, having a greater diameter than the body portion 421.

The cylinder 100 may have one or more second flanges 120. The second flange 120 may protrude from the outer circumferential surface of the cylinder 100. A plurality of the second flanges 120 may be spaced apart from each other along the circumferential direction of the cylinder 100. A plurality of the second flanges 120 may be spaced apart from each other along the axial direction of the cylinder 100.

The second flange 120 may have a second through-hole 121. The second through-hole 121 may be formed in the second flange 120. A portion of the second coupling member 420 may pass through the second through-hole 121.

The second through-hole 121 may have a greater diameter than the body portion 421 of the second coupling member 420 and have a lesser diameter than the head portion 422 of the second coupling member 420. Accordingly, the body portion 421 of the second coupling member 420 may pass through the second through-hole 121.

The caliper body 200 may have a second tab 200b, corresponding to the second through-hole 121. The second tab 200b may be recessed in the inner surface of the main body 201 of the caliper body 200 facing the cylinder 100. A screw thread may be formed on the inner surface of the second tab 200b. This may enable a screw-coupling with the body portion 421 of the second coupling member 420 passing through the second through-hole 121.

The caliper body 200 may have a second suspension portion 220. The second suspension portion 220 may be formed on the main body 201 of the caliper body 200 facing the cylinder 100, and protrude from the inner surface of the main body 201. The second suspension portion 220 may be positioned on one side of the second tab 200b, making contact with the outer surface of the second flange 120, thereby supporting the second flange 120.

A plurality of the second coupling members 420 is provided to couple the cylinder 100 with the caliper body 200 in the second direction (D2), and a plurality of the second suspension portions 220 is provided on the caliper body 200, making contact with the outer surface of the second flange 120 and thereby supporting the second flange 120. These components may be capable of supporting both a shear load, generated in the axial direction of the cylinder 100, and a vertical load, generated in a direction orthogonal to the axial direction of the cylinder 100, when the caliper body 200 generates braking force, thereby preventing deformation of the caliper body 200.

In other words, it is possible to prevent the deformation that could cause a gap between the main body 201 of the caliper body 200 and the plate 203 of the caliper body 200, with respect to the bridge 202 of the caliper body 200, due to both shear and vertical loads that are applied to the caliper body 200 when generating braking force by the caliper body 200.

A brake apparatus 1 for a vehicle according to the second embodiment of the present disclosure may further include a damper member 520. The damper member 520 may be interposed between the cylinder 100 and the caliper body 200. In other words, the damper member 520 may be affixed to the inner surface of the main body 201 of the caliper body 200, which surrounds cylinder 100 and makes contact with the outer circumferential surface of the cylinder 100.

The damper member 520 may be made of an elastically deformable material. The elastically deformable material may include rubber, sponge, and the like. The damper member 520 may absorb vibration so that the vibration, generated when the caliper body 200 generates braking force, is not transmitted to the vehicle body. The brake apparatus 1 for a vehicle according to the embodiments of the present disclosure can ensure the rigidity of the caliper body 200 through a plurality of coupling members 400 that couple the cylinder 100 with the caliper body 200, and a plurality of suspension portions 210 and 220 that support the flanges 110 and 120. These components bear a shear load when the caliper body 200 generates braking force, thereby minimizing the load applied to the coupling member 400.

The brake apparatus 1 for a vehicle according to the embodiments of the present disclosure can increase profitability by improving processes and assembly to enhance productivity and production efficiency.

The present disclosure has been described with reference to the embodiments illustrated in the drawings. Although exemplary embodiments of the disclosure have been disclosed for illustrative purposes, those skilled in the art will appreciate that various modifications and equivalent embodiments are possible. Thus, the true technical scope of the disclosure should be defined by the following claims.

What is claimed is:

1. A brake apparatus for a vehicle comprising:
a cylinder housing a piston;
a caliper body disposed on an outer side of the cylinder and surrounding a portion of the cylinder;
a driver coupled with the cylinder and generating driving force to move the piston; and
a coupling member coupling the cylinder with the caliper body.

2. The brake apparatus of claim 1, wherein
the coupling member comprises one or more first coupling members coupling the cylinder with the caliper body in a first direction.

3. The brake apparatus of claim 2, wherein
the caliper body has one or more first through-holes through which a portion of the respective first coupling members passes, and the cylinder has one or more first flanges protruding from an outer circumferential surface of the cylinder.

4. The brake apparatus of claim 3, wherein
each of the first flanges has a first tab, coupled with a corresponding one of the first coupling members passing through a corresponding one of the first through-holes.

5. The brake apparatus of claim 4, wherein
the caliper body has one or more first suspension portions, protruding from an inner surface of the caliper body and making contact with an outer surface of a corresponding one of the first flanges.

6. The brake apparatus of claim 1, wherein
the coupling member comprises one or more second coupling members coupling the cylinder with the caliper body in a second direction.

7. The brake apparatus of claim 6, wherein
the cylinder has one or more second flanges protruding from an outer circumferential surface of the cylinder, wherein each of the second flanges has a second through-hole through which a portion of a corresponding one of the second coupling members passes.

8. The brake apparatus of claim 7, wherein
the caliper body has one or more second tabs, each of which is recessed in an inner surface of the caliper body and coupled with a corresponding one of the second coupling members passing through a corresponding one of the second through-holes.

9. The brake apparatus of claim 8, wherein
the caliper body has one or more second suspension portions, each protruding from an inner surface of the caliper body and making contact with an outer surface of a corresponding one of the second flanges.

10. The brake apparatus of claim 1, further comprising one or more damper members interposed between the cylinder and the caliper body, and elastically deformable.
